(19) United States
(12) Patent Application Publication
(10) Pub. No.: US 2015/0242546 A1
(43) Pub. Date: Aug. 27, 2015

(54) Method of Cloth Simulation using Constrainable Multigrid

(71) Applicants: Inyong JEON, Seoul (KR); Kwang-Jin Choi, Seoul (KR); Tae-Yong Kim, Seoul (KR); Bong-Ouk Choi, Seoul (KR); Hyeong-Seok Ko, Seoul (KR)

(72) Inventors: Inyong JEON, Seoul (KR); Kwang-Jin Choi, Seoul (KR); Tae-Yong Kim, Seoul (KR); Bong-Ouk Choi, Seoul (KR); Hyeong-Seok Ko, Seoul (KR)

(21) Appl. No.: 14/187,106

(22) Filed: Feb. 21, 2014

(51) Int. Cl. G06F 17/50

(52) U.S. Cl. CPC G06F 17/5009

(57) ABSTRACT

A method of cloth simulation using a constrainable multigrid is provided. The method includes steps of: calculating a change of geometry of the mesh of nodes at a plurality of time steps using a multigrid method by solving a time-varying partial differential equation at multiple resolutions or levels; providing a hierarchical mesh through restriction or coarsening by down-sampling from level m to m−1 or prolongation or interpolation by up-sampling from level m to m+1; transferring soft constraints between different hierarchical levels using a damper-based constraint method; updating the position vector x and the velocity vector v of the mesh nodes; and displaying an updated state of the mesh of nodes using updated position vector x and velocity vector v on a display.

### RELATED APPLICATION

This application is a non-provisional application corresponding to Provisional U.S. Patent Application Ser. No. 61/767,702 for “Method of Cloth Simulation using Constrainable Multigrid” filed on Feb. 21, 2013.

### INCORPORATION BY REFERENCE

The Provisional U.S. Patent Application Ser. No. 61/767,702 and all the reference papers are incorporated by reference into this disclosure as if fully set forth herein.

### SUMMARY OF INVENTION

A method of cloth simulation using a constrainable multigrid is provided. The method comprises steps of:

a) mapping information of geometry of N material points, of the cloth into a mesh of nodes, having a 3N position vector x, a 3N×3N mass matrix M, and a 3N velocity vector v;

b) calculating a change of geometry of the mesh of nodes at a plurality of time steps using a multigrid method by solving a time-varying partial differential equation at multiple resolutions or levels; and

c) providing a hierarchical mesh through restriction or coarsening by down-sampling from level m to m−1 or prolongation or interpolation by up-sampling from level m to m+1;

d) transferring soft constraints between different hierarchical levels using a damper-based constraint method;

e) updating the position vector x and the velocity vector v of the mesh nodes; and

f) displaying an updated state of the mesh of nodes using updated position vector x and velocity vector v on a display,

wherein the coarsening of mesh is performed by coarsening a system matrix of the time-varying partial differential equation through the damper-based constraint method,

wherein the system matrix is changed by damper matrices and displacement forces.

The time-varying partial differential equation may be given
Eq. 1,
   which is discretized by an implicit integration method to
Eq. 2,
   where h is a time-step, f is a 3N force vector, and n is a superscript of the time-step.

The mesh may be triangular, wherein the step for providing a hierarchical mesh comprises a constrained Delaunay triangulation to generate finer or coarser meshes, and wherein for prolongation each triangle having three parent particles at level m is subdivided into four smaller triangles by inserting mid-particles at mid-points of three edges, and for restriction the mid-particles are removed.

A 3×3 damper matrix Dᵢ, a directional damper, constrains particle is movement along a particular direction by being added to a block diagonal term of the system matrix in
Eq. 3,
   where
Eq. 4.

The Dᵢ may be given
Eq. 4,
   where nᵢ is a prohibited direction of the particle i.

The directional damper may be a sum of a 3×3 orthogonal projector and a 3×3 complementary projector.

The displacement force may be given by
Eq. 5,
   where dᵢ a displacement determined by a movement of a solid object in contact with the particle i if there is a positional change along the constrained direction.

The step for transferring soft constraints to a coarser levels from level m+1 to level m may comprise a step for determining which particles are constrained in level m, for each constrained particle which type of constraint is to be used, and what value is used for constraint coefficients.

Coarsening may be applied recursively until a desired coarser level is reached.

The method may further comprise a step for performing a plurality of relaxations to reduce residual errors at each level, wherein the step comprises a preconditioned conjugate gradient scheme and a Gauss-Seidal scheme.

The step for providing a hierarchical mesh may be performed by an algorithm

Algorithm 1.

### BRIEF DESCRIPTION OF DRAWINGS

The patent or application file contains at least one drawing executed in color. Copies of this patent or patent application publication with color drawing(s) will be provided by the Office upon request and payment of the necessary fee.

These and other features, aspects and advantages of the present invention will become better understood with reference to the accompanying drawings, wherein:

FIG. 1 shows a hierarchical mesh construction according to an embodiment of the invention.

FIG. 2 shows a sliding constraint. The particle i is in contact with the solid at the position xⁿᵢ at tⁿ. x^{guess}ᵢ is the position of that contact point at tⁿ⁺¹, thus dⁿᵢ is a rough guess of the translation that is needed to maintain the contact. Solving Equation (3) with this sliding constraint guarantees that the particle i comes on the tangential plane at tⁿ⁺¹.

FIG. 3. This images illustrate the constrained particles in different levels of the proposed multigrid method at a particular time step. The color of the particle reflects the current value of the coefficient k_{c}. The red particles visualize sliding constraints, and the blue particles around the top corners of the handkerchief visualize point to-point constraints. The orange and sky blue particles in the two rightmost images show that k_{c} is reduced in the process of coarsening. In order to show how point-to-point constraints are coarsened to lower level, we constrained the particles next to the corners instead of the corner particles themselves.

FIG. 4 shows comparison of the convergence for different choices of the pre-smoother, post-smoother, and other iterative methods in simulating one time step. The horizontal axis represents the computation time (msec). The vertical axis is the relative residual error measured in every pre/post-smoothing iteration at the finest level. The numbers of pre-smoothing and post-smoothing are 5 and 10, respectively. (For MPCG, CG and GS, we measured every iteration.)

FIG. 5 Shows scenes experimented: (a) Swinging Cloth, (b) Sphere Test 1, © Sphere Test 2, (d) Cylinder Test.

FIG. 6 shows additional scenes experimented: (a) One-piece, (b) Ruffle Blouse, © Jeans. Although the experiments for Ruffle Blouse and Jeans were done over a single simulation, book-keeping for the measurement of the computation time was done separately.

FIG. 7 shows comparison of the performance for different choices of the pre-smoother and the post-smoother. The number of vertices was 48,534 and time step size was 11.11 ms. The numbers of the pre-smoother and post-smoother applications were 5 and 10, respectively, and M=3 for all three cases shown in this graph.

FIG. 8 shows frictional Sliding Constraint Test. We dropped six pieces of fabric with different k_{f} on the inclined plane at the same time. The number of vertices of each piece is 3,717 and k_{f} are 0, 0.01, 0.02, 0.04, 0.08 and 0.3 from left to right. (a) and (b) are the 1st and 30th frames of the experiment, respectively.

### DETAILED DESCRIPTION EMBODIMENTS OF THE INVENTION

We present a new technique which can handle both point-to-point and sliding constraints in the multigrid framework. Although the multigrid method can theoretically perform as fast as O(n), the development of a clothing simulator based on the multigrid method has been facing a major challenge: handling the constraints. Resolving constrains has been difficult in the multigrid because there has been no clear way to transfer the constraints existing in the finest level mesh to the coarser level meshes. This paper presents a new formulation based on soft constraints, which can transfer the constraints defined in the finest level to the coarser levels. Experiments are performed which show that the proposed method can solve the linear system up to 3-9 times faster in comparison with the modified preconditioned conjugate gradient method (MPCG) without quality degradation. Relative speed up with respect to MPCG is not sensitive to the amount of constraints in the system. The proposed method is easy to implement and can be straightforwardly applied to existing clothing simulators which are based on implicit time integration.

### 1 INTRODUCTION

REALISTIC, fast clothing simulation techniques have been an important issue in the computer graphics field over the past twenty years. Thanks to the achievements made in this field, it is now possible to create simulated clothing that is almost indistinguishable from real clothing. Such kinds of high quality clothing simulations call for some amount of computation thus are done in off-line, and used in the production of movies or feature animations. On the other hand, there are also some applications (e.g., gaming, on-line personalized clothing sales) in which realtime performance is important. The draping quality trades off with simulation speed. Nonetheless, as the clothing simulation technology is exposed to a wider audience, a strong demand has emerged for a realistic and fast simulation technique. This paper proposes a technique which can produce production-quality clothing simulations several times faster than previously proposed methods.

Simulation of clothing interacting with a body and objects can introduce thousands of sliding or point-to point constraints. The the preconditioned conjugate gradient (MPCG) method, which was introduced by Baraff and Witkin [1], has been a practical choice for solving large sparse systems of linear equations arising in clothing simulations, particularly for its capability of resolving constraints. Other approaches have been also practiced to resolve constraints; Bridson et al. [2] and Muller et al. [3] resorted to direct position/velocity manipulation.

Multigrid (MG) methods [4], [5], which use multiple resolutions (or levels) to solve a linear system, have been successfully applied to various problems such as fluid dynamics, image processing and deformable objects. When applied successfully, MG methods exhibit optimal (linear) time complexity. Unfortunately such optimal performance is not straightforwardly achievable in clothing simulation. A major challenge here is constraint handling; The simulators which have been developed based on the MG framework do not have proper constraint handling capability. We note that the above projection-based hard constraints, whether resolved while solving the linear system (MPCG) or after solving it (position alteration/velocity filtering), cannot be easily transferred between hierarchical levels, as it is difficult to decompose projections into sum of fine-level projections. Considering the smooth nature of the inter-level quantity exchanges (e.g., in interpolation and coarsening), we conclude that hard constraints are not suited for MG simulations.

This paper attempts the use of soft constraints, which can be implemented through the implicit filtering mechanism of the implicit time integration. We find that this new method handles sliding constraints and point-to-point constraints remarkably well in the MG framework. In handling the sliding constraints, the proposed method allows to add the effect of friction in a very simple way. Although the method is formulated with soft constraints, the experimental results show that the constraints resolution quality measured at the finest level is visually indistinguishable from ground-truth simulation results obtained by the MPCG method. Judging the overall simulation, there is no loss of quality compared to MPCG but runs up to 3-9 times faster depending on the mesh size. Relative speed up with respect to MPCG is not sensitive to the amount of constraints in the system.

The contributions of this paper are 1) the development of a new multigrid framework for clothing simulation which can accommodate constraints, and 2) the development of a particular procedure to transfer constraints between multigrid levels.

### 2 RELATED WORK

There exist numerous works on improving the quality of clothing simulations. For brevity, we review the most relevant work to ours, and refer readers to [6], [7].

### 2.1 Implicit Integration Methods

Since the seminal work of [1], implicit time integration has been a popular choice for high-quality off-line simulations.

To enhance accuracy, more refined methods such as the second order backward difference formula (BDF2) [8] and midpoint implicit integration [9] were tried. The framework has been enriched by various energy models [10], [11], [12], [13], [14] that could reproduce realistic movements of clothing materials.

### 2.2 Handling Constraints

Constrained dynamics have been widely investigated in computer graphics. Witkin et al. [15] classified the types of constraints and employed a penalty method to prevent illegal particle motions. Baraff and Witkin [1] presented the MPCG method that filtered out undesired particle DOFs during preconditioned conjugate gradient (PCG) iterations. Constrained Lagrangian mechanics were used for handling contact [16], for strain limiting [17] and for controlling cloth motions [18]. Unlike these approaches that integrate constraints as part of the system equation, Bridson et al. [2], Muller et al [3] and Thomaszewski et al. [19] treated constraints in the post-processing step after solving the linear system.

### 2.3 Hierarchical Approaches

Hierarchical approaches have been studied for the purpose of improving performance. Muller [20] proposed a hierarchical solver that improves convergence and speed of realtime cloth simulation based on the position based dynamics [3]. Wang et al. [21] developed a multi-resolution solver that improves global convergence in the strain limiting steps during deformable object simulations. Those two solvers used hierarchy only for resolving constraints, whereas Lee et al. [22] solved reduced versions of the implicit integration equation with dynamically adaptive meshes.

### 2.4 Multigrid

Multigrid (MG) method has proven to be effective for regular domain in various fields such as fluid simulation [23], elastic body simulation [24], [25], and image processing [26]. For unstructured mesh, one can use algebraic multigrid (AMG) or geometric MG on hierarchically defined meshes. AMG constructs hierarchy of operators directly from the system matrix [27], while geometric MG directly controls the structure of hierarchical meshes. The present work is based on the geometric MG method as in [28], [29].

### 2.5 Constraints in Multigrid

The standard multigrid methods are not directly applicable to clothing simulations (see Section 3.1 for the details). Oh et al. [29] proposed to use physically inspired coarsening techniques. Although the method only coarsened forces and Jacobians, it left the constraints unprocessed through the multigrid levels, resulting in poor convergence when there exist a large set of constraints. Lee et al. [22] overcame the problem by adaptively changing meshes, which led to improvements in the performance. However, the performance and accuracy of their method depended on the error correction step which is applied at the finest level. When a fixed number of correction steps were applied, the method may not guarantee the the desired precision (e.g. below residual error 1.e-5). McAdams et al. [25] used (an)isotropic Young's modulus for modelling constraints in character skinning animation and applied that model to multigrid. Although soft constraints are used in multigrid framework, their coarsening model is based on regular hexahedral lattice and is not directly applicable for simulating the frictional sliding between object and deformable mesh.

### 2.6 Upsampling Methods

Recently, the methods to combine physcially based coarse level simulations with efficient schemes to add fine level details have been actively studied. Muller and Chentanez [30] created wrinkles from a coarse result using efficient but approximate pseudo dynamics simulations. Wang et al. [31] and Aguiar et al. [32] used machine learning approaches to generate real-time wrinkles based on similar simulation examples for training. Feng et al. [33] and Rohmer et al. [34] achieved a detailed high-resolution wrinkling using non-linear operators, and Kavan et al. [35] used a linear up-sampling operator acquired from least square fitting of example simulation sequences. Although promising, these methods do not couple high resolution simulation back to coarser simulation, so simulation quality does not match that of fine level simulations; our method produces results that are visually indistinguishable from fine level simulations.

### 3 OVERVIEW

Physically-based clothing simulation can be formulated as a time-varying partial differential equation

$$\ddot{x} = {M}^{- 1} ( - \frac{\partial E}{\partial x} + F ) , \qquad ( 1 )$$

where x′ is the acceleration, M is the mass, E is the scalar representing the energy associated with internal deformations, F is the sum of external forces including gravity, air-drag, constraint forces, and collision force. Employing a method of implicit integration [1], Equation (1) can be written into a linear system

$$( M - h \frac{\partial f}{\partial v} - {h}^{2} \frac{\partial f}{\partial x} ) Δ x = {hMv}^{n} + {h}^{2} ( {f}^{n} - \frac{\partial f}{\partial v} {v}^{n} ) , \qquad ( 2 )$$

where h is the time-step, M is the 3N×3N mass matrix, f is the 3N force vector which is the sum of the external forces and the internal forces stemming from the internal energy, x is the 3N position vector, v is the 3N velocity vector, n is the superscript of the time step. For direct handling of positional constraints, we use the above formulation, in which the unknowns are position changes rather than velocity changes. In the subsequent writing, we denote the left hand side of the above equation by AΔx and the right hand side by b. The system matrix A is 3N×3N block-symmetric and can be made positive definite by dropping some of the Jacobian terms when the cloth is in tensile compression [10]. Thus, this equation can be solved using iterative methods such as (preconditioned) conjugate gradient, Gauss-Seidel relaxation, or multigrid.

### 3.1 Overview of Multigrid Method in Cloth Simulation

The purposes of this section are two folds: (1) it overviews the multigrid method in the context of clothing simulation, and (2) it describes the basic design of the multigrid framework this paper uses based on the prior work. Novel developments this paper makes for the constrainable multigrid are presented in Section 4.

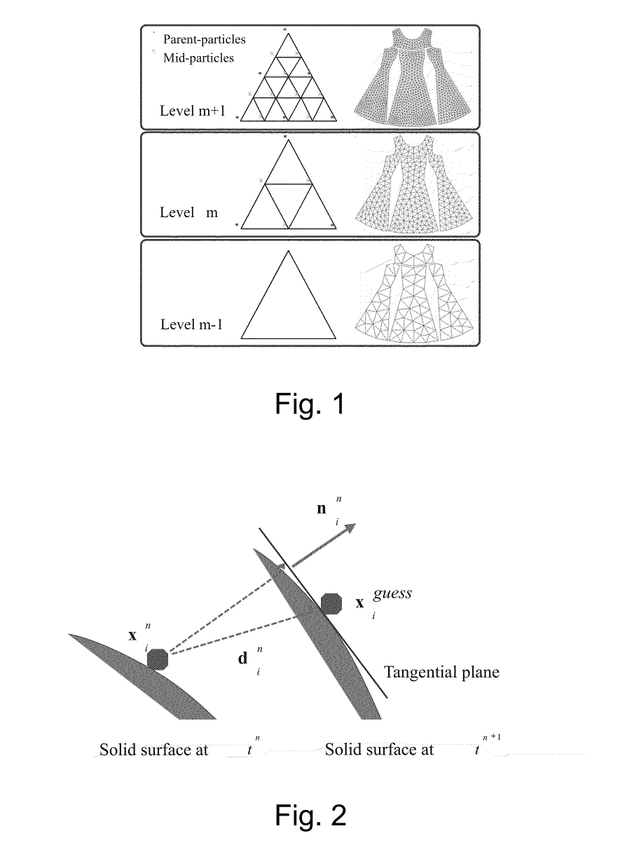

The multigrid method [4], [5] is a numerical method to solve AΔx=b by solving the system at multiple resolutions (or levels) and exchanging the resulting quantities across the levels. We use the variable in to refer to the current level as shown in FIG. 1, 1 and M being the coarsest and finest levels, respectively. (In this work, we used M=4 when the number of vertices is over 200,000, otherwise we used M=3.) Down-sampling from level in to m−1 is called restriction or coarsening, and up-sampling from level in to m+1 is called prolongation or interpolation.

Multigrid method can theoretically perform as fast as O(n). The basic idea of the multigrid method is to accelerate the global convergence by solving the residual equation in the coarser level mesh. In the standard multigrid method, the restriction operator R and the prolongation operator P are used to coarsen the system matrix, i.e., Aₘ=RAₘ₊₁P. Unfortunately, this operation does not produce properly coarsened matrices for cloth simulation. Oh et al. [29] introduced a restriction operator suited for multigrid cloth simulation. They proposed that the system matrix could be decomposed into the mass matrix, the internal force Jacobian, and the external force Jacobian. With this decomposition, each decomposed matrix could be coarsened in a physically meaningful way. This paper adopts the decomposition, and develop additional parts which are needed to properly handle constraints in clothing simulation.

We now describe basic details in our development of a multigrid cloth simulator. We explain how the mesh is prepared for hierarchical usage, and how the smoothing, restriction, and prolongation operators are designed.

### 3.1.1 Hierarchical Mesh Preparation

First, we employ the constrained Delaunay triangulation to generate the coarsest mesh to approximate a given cloth patterns. Second, each triangle is subdivided into four smaller triangles by inserting particles at the mid-points of the three edges, as shown in FIG. 1. Each inserted particle is called a mid-particle (labelled yellow in FIG. 1) and two ends of the edge are called its parent-particles (labelled green in FIG. 1). Then, an optimization is performed to make the hierarchical mesh better-fit the pattern and wellshaped. This procedure is repeated recursively until the finest mesh level is reached. For the optimization, we adopt the iterative method of [36].

### 3.1.2 Smoother

In the standard multigrid method, a few relaxations are performed to reduce residual errors at each level. Typical choices for such smoothing steps are local iterative methods such as the Gauss-Seidel or Jacobi that quickly kill the highest frequency terms of the errors. In this paper, we present a new smoothing scheme that combines both preconditioned conjugate gradient (as a pre-smoother) and Gauss-Seidel (as a post-smoother), achieving better convergence than choice of a single method. See Section 5 for details.

### 3.1.3 Restriction

For the restriction operator, we employ the full-weighting scheme used in Oh et al. [29], which evenly distributes the residual associated with a mid-particle to its two parentparticles.

### 3.1.4 Prolongation

For the prolongation operator, we use the linear interpolation as in the standard multigrid; the mid-particle error is given as the average errors of the two parent-particles.

### 4 METHOD

Simulations of clothing interacting with a character's body can introduce thousands of constraints. Therefore, without a proper method to handle the constraints, all the benefits of using the multigrid method quickly diminishes. In a typical setting, a user supplies constraints for the finest mesh, either with direct control or indirectly through collisions. The constraints are difficult to transfer to coarser levels, since it is impossible to control the degree of constraining of the hard constraints. There is no in-between for these hard constraints; a particle is either constrained or not constrained. Ignoring the constraint altogether during coarsening step would result in the loss of some critical information for coarser level simulation.

On the other hand, if we decide to pass the constraints associated with the mid-particle onto both of its parentparticles, the coarser level movement would be more constrained than it is intended by the user. In any case, transferring the hard constraints from the finer level to the coarser level is problematic. We initially experimented with several constraint distribution strategies for a hard constraint-based multigrid method, but discovered that these methods either fail to converge or converge at sluggish rates.

### 4.1 Damper-Based Constraint Method

In order to remedy this problem, we use soft constraints for our framework. We treat each constraint as a damper, and develop a multigrid framework based on this idea. This damper-based constraint method (DECM) is motivated by the filtering effect of the implicit time integration (Equation (2)). We constrain each particle's movement along a particular direction by adding a new term to the system matrix, in addition to the force-Jacobian term. More specifically, to constrain the movement of particle i, we add a 3×3 matrix Dᵢ (which we call the directional or omnidirectional damper based on the types of constraints) to the block diagonal term of the system matrix in the following equation

$$( M - h \frac{\partial f}{\partial v} - {h}^{2} \frac{\partial f}{\partial x} + {h}^{2} D ) Δ x = {hMv}^{n} + {h}^{2} ( {f}^{n} + {f}_{dlsp} - \frac{\partial f}{\partial v} {v}^{n} ) , \qquad ( 3 )$$

where

f_{disp}(f_{disp,1}^{T},f_{disp,2}^{T}, . . . ,f_{disp,N}^{T})^{T}ε [symbol] ^{3N}

D=diag{D₁,D₂, . . . ,D_{N}}ε [symbol] ^{3N×3N},

We use the following formula for Dᵢ

$${D}_{i} = \{ \begin{matrix}0 & ( free ) \\ {k}_{c} {n}_{i} {n}_{i}^{T} + {k}_{f} ( I - {n}_{i} {n}_{i}^{T} ) & ( directional ) \\ {k}_{c} I & ( omnidirectional )\end{matrix} , \qquad ( 4 )$$

where nᵢ is the prohibited direction of the particle i. The directional damper is the sum of a 3×3 orthogonal projector and a 3×3 complementary projector. The orthogonal projector leaves the other two dimensional DOFs, dampening the movement of particle in the prohibited direction. k_{c} is used to control the degree of dampening. The complementary projector yields the effect of friction on the tangential plane in FIG. 2. k_{f} is the frictional coefficient and typically much smaller than k_{c}. The omnidirectional damper is a 3×3 identity matrix which constrains the particle to a fixed point in 3D. Adding the above dampers to the system matrix creates the effect of increasing the inertia of the particles for the current simulation time step.

If there is a positional change that we wish to enforce along the constrained direction as shown in FIG. 2, then we add the following force term to the right hand side of the equation as shown in Equation (3)

f_{disp,i}=Dᵢdᵢ (5)

where dᵢ is the displacement determined by the movement of the solid object in contact with the cloth particle i. f_{disp,i} is named as the displacement force because it ends up producing a displacement Dᵢdᵢ along the constrained direction. Note that Dᵢdᵢ is not the desired displacement itself but its projected version. The addition of this force does not make the linear system unstable because that force is introduced in conjunction with the corresponding damper to the system matrix.

We note that the above method is different from the standard damping forces added to implicit integrators, even though it may appear so at first sight. In the usual damping force models, the force term on the right hand side and its Jacobian in the system matrix are always paired. In contrast, Dᵢ and f_{disp,i} do not necessarily come in pair; f_{disp,i} is added only when some displacement needs to be generated along the constrained direction. Note that we do not use the velocity Jacobian

$$\partial \frac{\partial f}{v}$$

for constraints, which can add artificial viscosity to the system if the standard spring damper was used for soft constraints.

This seemingly small deviation plays an important role in coarsening the constraints consistently across the hierarchical level meshes, when used in the context of the multigrid method along with the inter-level constraint transfer procedure introduced in Section 4.2.

### 4.2 Coarsening the System Matrix

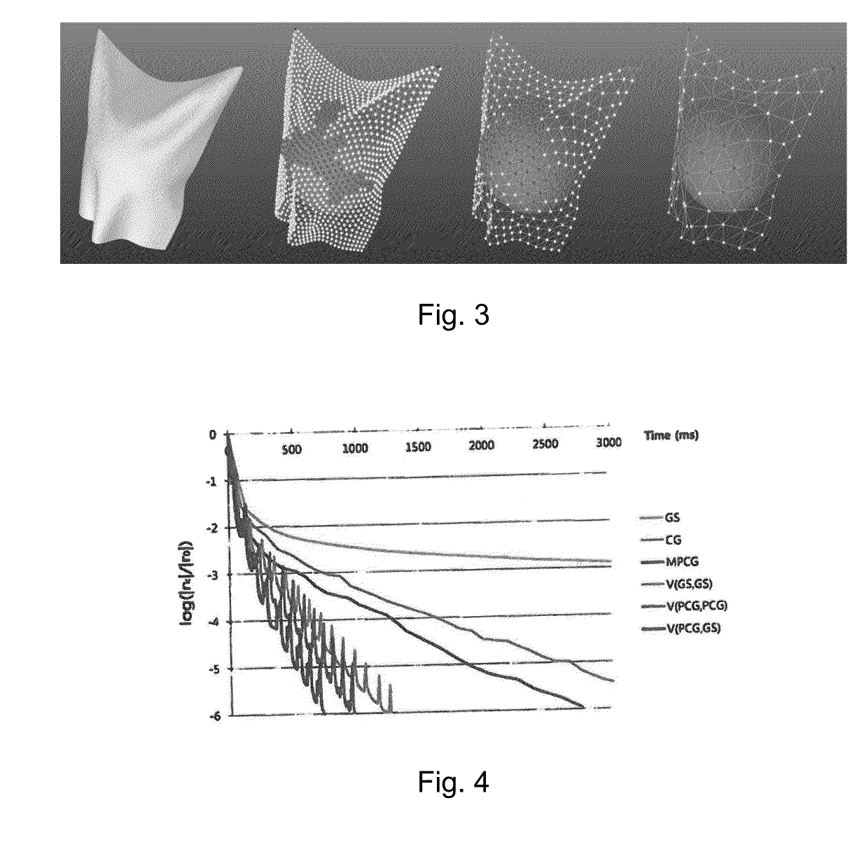

We now describe how the two extra terms (damper matrices and displacement forces) are coarsened and restricted to the coarser level mesh. We describe the coarsening process for the system matrix in this section, which is demonstrated in FIG. 3, and the one for the residual restriction in the next section.

For usual forces and Jacobian terms, we use Oh et al.'s [29] coarsening procedure, which works on Aₘ₊₁ and produces an intermediate result A^{˜}ₘ. At this stage, constraints are not reflected in the system.

We then transfer constraints to the coarser levels as follows. Suppose that m+1 is the current level and in is the coarser level into which we want to coarsen the system matrix. We determine (1) which particles should be constrained in level m, (2) for each constrained particle, which type of constraint should be used, and (3) what value should be used for the constraint coefficient(s). This process is completed by adding appropriate dampers to A^{˜}ₘ based on the above decisions, producing a coarsened matrix Aₘ. We apply the coarsening procedure recursively until we reach the coarsest level.

Let P_{m,i} be an arbitrary particle in level in and let P_{m+1,i} be its copy in level m+1. Let P_{m+1,j} (j=j₁, j₂, j₃ . . . ) be the particles that form P_{m+1,i}'s one-ring neighborhood. Let Nm+1,i={Pm+1,i,Pm+1,j₁,Pm+1,j₂,Pm+1,j₃ . . . } be the set of particles consisting of the above one-ring neighborhood and P_{m+1,i} itself. Let c_{m+1,i} be the set of the constraints existing on the particles in N_{m+1,i}. Note that |C_{m+1,i}|=|N_{m+1,i}| (where ∥ denotes the cardinality of a set) since unconstrained particles may be present. The situation can be categorized into the following three cases, and we explain how P_{m,i} is constrained in level m for each case.

### 4.2.1 No-Constraint Case

If |C_{m+1,i}|=0, then P_{m,i} is not constrained in level m.

### 4.2.2 Non-Original Constraint Case

If P_{m+1,i} is not originally constrained in the finest level mesh, then we constrain P_{m,i} with the result of blending the constraints in C_{m+1,i}. The constraint type of P_{m,i} follows the particle's type which has the maximum constraint coefficient among C_{m+1,i}.

If the constraint type of P_{m,i} turns out a point-to-point constraint, D_{m,i} should be an omnidirectional damper. Its constraint coefficient k_{c,m,i} is determined by

$${k}_{c , m , i} = {\sum }_{l} {ω}_{l} {k}_{c , m + 1 , l} , \qquad ( 6 )$$

where l is an element's index of C_{m+1,l} which is a subset of C_{m+1,i} excluding the sliding constraints. The weighting factor ωₗ can vary with the interpolation scheme. We found 0.5 for the particles P_{m+1,j} and 1.0 for the particle P_{m+1,i} worked well. When the weighted sum exceeds a original coefficient of point-to-point constraint in the finest level, the value is clamped to prevent the coarse level particle from being excessively constrained.

If the constraint type of P_{m,i} turns out a sliding constraint, D_{m,i} should be a directional damper. In a directional damper, we need to determine the constrained direction, constraint coefficient and frictional coefficient as in Equation (7) and (8).

$$\begin{matrix}{n}_{m , i} = \frac{{\sum }_{l} {ω}_{l} {k}_{c , m + 1 , l} {n}_{m + 1 , l}}{\vert {\sum }_{l} {ω}_{l} {k}_{c , m + 1 , l} {n}_{m + 1 , l} \vert} & ( 7 ) \\ {k}_{m , i} = {\sum }_{i} {ω}_{l} {k}_{m + 1 , l} , & ( 8 )\end{matrix}$$

where l is an element's index of C_{m+1,l} which is a subset of C_{m+1,i} excluding the point-to-point constraints. The constraint coefficient and frictional coefficient are determined as in Equation (8) and the weighting factor ωₗ is determined in the same way as in the point-to-point constraint case.

### 4.2.3 Original Constraint Case

If P_{m+1,i} is originally constrained in the finest level mesh, we let P_{m,i} have the same constraint type and damper as P_{m+1,i} has, regardless of the presence of additional constraints in N_{m+1,i}. The rationale here is that the nonoriginal constraints created in the coarse level m<M are for emulating the original constraints. If P_{m,i} is originally constrained, then that original constraint is precisely what is desired for P_{m,i} in level m, thus blending any other constraints is not necessary.

### 4.3 Restricting the Residual

The displacement forces are not different from usual forces on the right hand side b of the linear system for multigrid purposes. So they are restricted with the full-weighting scheme used in the standard multigrid method [5].

ALGORITHM SUMMARY

Algorithm 1 Multigrid (A_{M}Δx_{M},b_{M})
while i < iₘₐₓ or convergence is not reached do

V-Cycle(M,A_{M},Δx_{M},b_{M})

end while

Algorithm 2 V-Cycle (m,Aₘuₘ,fₘ)
for i = 1 to num of pre-smoother do

Pre-Smoother(Aₘuₘ,fₘ)

end for
Resₘ = fₘ − Aₘuₘ
fₘ₋₁ = Restrict(Resₘ)
if m−1 is coarsest level then

coarsest solver( )

else

V-Cycle(m − 1,Aₘ₋₁uₘ₋₁,fₘ₋₁)

end if
errorₘ = Prolong(uₘ₋₁)
uₘ = uₘ + errorₘ
for i = 1 to num of post-smoother do

Post-Smoother(Aₘuₘ,fₘ)

end for

Algorithm 1 summarizes our multigrid solver Multigrid( ) which calls V-Cycle( ) in Algorithm 2 repeatedly until convergence. Better performances could be obtained using two different types of smoothers, namely, the PCG method and the Gauss-Seidel method; The PCG method is used for the pre-smoother (the smoother for the downstroke of the V-cycle), and the Gauss-Seidel iteration (GS) is used for the post-smoother (the smoother for the upstroke), as shown in Algorithm 2. The rationale behind using the mixture of PCG and GS for smoothing is to combine the advantages of each iterative method. For the case of cloth simulations, PCG is better than any other smoothers in global convergence. In the down-stroke, in fact, PCG is effective in reducing the overall frequency components of the error at each level. GS, on the other hand, is a local smoother that very quickly dampens out high-frequency components of the error without vitiating other frequency error components. This property of GS works effectively in the up-stroke. As shown in FIG. 4, using GS post-smoothing behind PCG pre-smoothing is quite efficient in reducing residual errors without stalling.

In the pre-smoother step and the coarsest solver, we use PCG with a 3N×3N block diagonal preconditioner (Jacobi preconditioning), and in the post-smoother step, we use a 3×3 block-wise Gauss-Seidel method. GS is parallelized by adopting a multi-coloring algorithm in a triangular mesh [37]. For simplicity, we just apply same colors to the particles that are not updated simultaneously. Each set of same colored particles are updated in parallel. For PCG and MPCG, we also parallelize mat-vec multiplications for a fair comparison for all experiments.

The V-Cycle involves two different iterative methods, thus the stopping criteria need some consideration. Typically, the PCG method uses r|Pr to check for convergence, where P is the preconditioner and r is the residual r=b−AΔx. On the other hand, the GS method would use r|r. For consistency, we measure residual errors with r|Pr in both Algorithm 1 and 2.

### 6 RESULTS

### 6.1 Implementation

We implemented the proposed method for parallel performance using OpenMP. All simulations were performed on a single desktop computer with Intel Core i7(3930K) 3.20 GHz CPU and 12 GB RAM. Final rendering (except for the real-time footage) was done with V-ray and Maxwell via Maya. For implementing the clothing simulator, we used the triangle-based energy models [1] for the in-plane deformation and the hinge-based model [11] for the out-of plane deformation. For the time integration, we employed the second order backward difference formula [8]. Although we formulated our method based on the first order backward difference formula, extending to the second order is straightforward.

Collision handling can be classified into two categories; solid-cloth collision and cloth-cloth collision. For solid cloth collision, we detected the penetrations between cloth's vertices and solid's triangles. For the case of contact, we applied the (frictional) sliding constraints on the vertices which were in contact with solid's surface. For cloth-cloth collision, we handled both triangle-vertex and edge-edge collisions. (In the production of the real-time footage, we ignored cloth-cloth collisions.) Unlike solid-cloth collision, cloth-cloth collision is not an obstacle in developing a multigrid framework. As addressed in [29], for the colliding vertex-vertex pairs, we applied strong spring forces to push them apart. The spring force and its Jacobian can be incorporated into multigrid framework in the same way as the triangle-based forces. We adopted [38] for calculating the repulsive and attractive forces and [2] for the postprocessing after solving the linear system.

For checking the convergence in all simulations reported in this paper, we referred both relative and absolute residual errors, the stopping criteria being 10-⁴ and 10-⁵, respectively. If the initial L2 norm of residual is too small for the case of almost reaching a static state, relative error criterion is unnecessarily excessive. Thus, the iteration terminates if either of the errors is below the criteria.

### 6.2 Evaluation

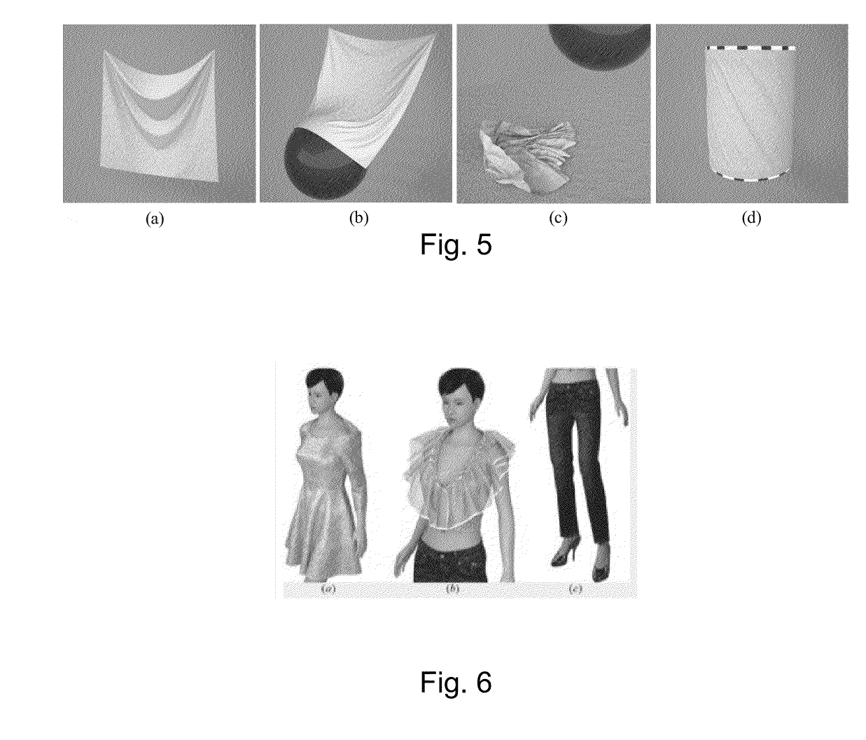

We experimented our method with various cloth and clothing examples ranging from simple handkerchiefs to complex garments as shown in FIGS. 5 and 6. To evaluate the speed-up, we measured the average computation time for solving the linear system with the MPCG and with the proposed multigrid (MG) method. We considered MPCG to be the ground truth for handling the constraints. Table 1 summarizes the statistics collected during the simulations. It shows that the proposed method is about 39 times faster than MPCG. The speed up in the cases of Sphere Test 2 and Ruffle Blouse, which involve more small wrinkles than the rest, is less than the other cases. It is because the multigrid method essentially is good at removing smooth parts of error using coarse-grid correction. Although the performance gain varies, we note that the proposed method is by far superior to MPCG in the performance without degradation of simulation quality even in collision-intensive cases.

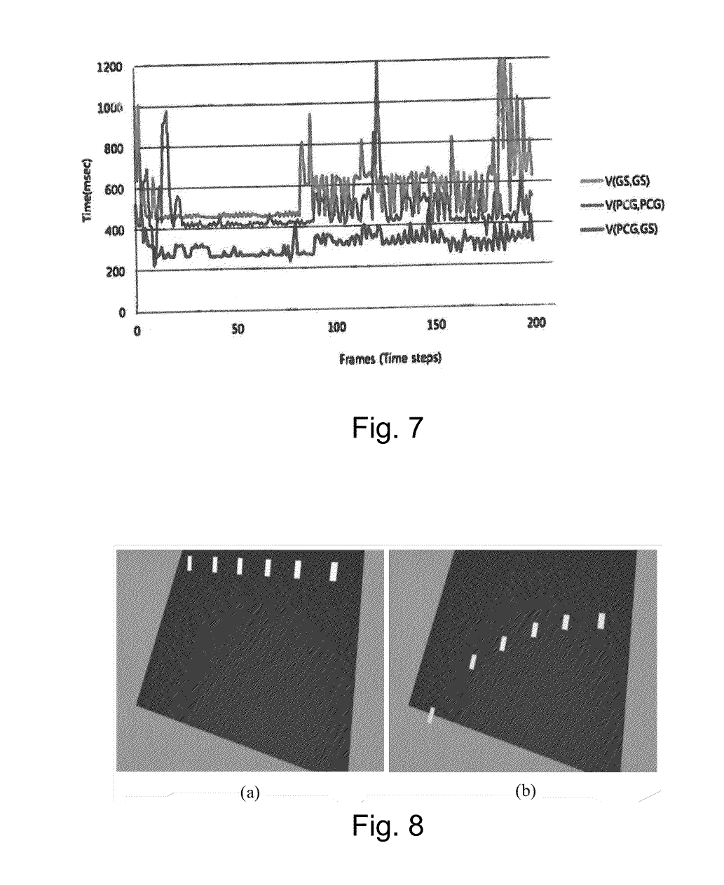

The speed-up of MG with respect to MPCG does depend on the mesh complexity of the finest level mesh. We constructed the one-piece with increasing mesh complexities as shown in Table 2 and ran MPCG and MG, holding other conditions the same. The table demonstrates that the speedup increases as the mesh complexity increases. (Although the speed up depends also on the time step size, the material properties, and the design of the outfit, the dependency on those factors is minor and does not exhibit any clear tendency compared to the mesh complexity.) FIG. 7 shows how the speed of the proposed multigrid method is related with the choice of the smoother. V(PCG,GS) represents the case when the preconditioned conjugate gradient method is used for the pre-smoother and Gauss-Seidel method is used for the post-smoother. It plots, for each frame (x-axis) of the One-piece simulation, how much time (y-axis) is taken for solving the linear system. In the proposed method, constraints are enforced by solving the linear system of Equation (3) without any additional filtering step as in the MPCG method. Thus, a local smoother such as Gauss-Seidel method can be applied to the V-Cycle. According to this experiment (and other unreported experiments), V(PCG,GS) is about 1.52 times faster than the other choices.

TABLE 1

| | #vertices/ | Time step | Total | Density/Stretch/ | | Rel/Abs | V(pre, | Average | Average time(ms) | | Speed |
|---|---|---|---|---|---|---|---|---|---|---|---|
| Scenes | #triangles | (ms) | flames | Shear/Bend | k_{c}/k_{f} | res. | post) | # of V | MPCG | MG | up |
| Swinging Cloth | 24481/48320 | 11.11(1/90 s) | 600 | 1e−5/200/15/0.01 | 200/0 | 1e−4/1e−5 | V(5, 10) | 2.99 | 722.41 | 74.78 | x9.66 |
| Sphere Test 1 | 24481/48320 | 11.11(1/90 s) | 600 | 1e−5/150/10/0.001 | 150/0 | 1e−4/1e−5 | V(5, 10) | 2.97 | 512.85 | 73.82 | x6.94 |
| Sphere Test 2 | 25299/50032 | 11.11(1/90 s) | 600 | 1e−5/100/10/0.005 | 10/0 | 1e−4/1e−5 | V(5, 10) | 5.51 | 524.26 | 142.94 | x3.66 |
| Cylinder Test | 23312/46112 | 11.11(1/90 s) | 1000 | 1e−5/50/15/0.005 | 50/0 | 1e−4/1e−5 | V(5, 10) | 2.43 | 281.78 | 56.23 | x5.01 |
| One-piece | 48534/96384 | 11.11(1/90 s) | 600 | 1e−5/100/10/0.01 | 100/0 | 1e−4/1e−5 | V(5, 10) | 4.43 | 1443.94 | 297.45 | x5.19 |
| Ruffle Blouse | 54170/106816 | 11.11(1/90 s) | 600 | 1e−5/80/5/0.008 | 80/0 | 1e−4/1e−5 | V(5, 10) | 5.86 | 1989.65 | 423.58 | x4.69 |
| Jeans | 45455/90544 | 11.11(1/90 s) | 600 | 1e−5/150/15/0.3 | 150/0 | 1e−4/1e−5 | V(5, 10) | 3.73 | 1205.35 | 235.42 | x5.12 |

This table summarizes the statistics in simulating the seven scenes of FIGS. 5 and 6: from left to right, the number of vertices and triangles, the time step size, the

number of total frames (time steps), the material properties of cloth, constraint coefficient, the stopping criteria for the relative and absolute errors, the number of pre-smoothing and post-smoothing in one V-Cycle, the average number of V-Cycles per each time step, the average

computation time per each time step. The average computation time here measured only the time taken for solving the linear system.

TABLE 2

| # vertices | 4,613 | 9,930 | 17,730 | 27,742 | 34,818 | 70,790 | 89,930 | 110,274 | 132,966 | 159,238 | 207,238 | 282,126 | 358,550 |
|---|---|---|---|---|---|---|---|---|---|---|---|---|---|
| MPCG | 26.21 | 72.41 | 298.28 | 596.76 | 994.87 | 2035.7 | 2940.1 | 3776.13 | 4813.77 | 6028.46 | 8671.51 | 12592.9 | 19874.2 |
| MG | 8.38 | 21.62 | 73.17 | 135.37 | 201.86 | 384.48 | 507.65 | 634.19 | 742.67 | 899.04 | 1238.54 | 1749.02 | 2315.11 |
| Speed up | x3.12 | x3.34 | x4.07 | x4.70 | x4.92 | x5.29 | x5.79 | x5.95 | x6.48 | x6.70 | x7.08 | x7.19 | x8.58 |

This table summarizes the time taken by the MPCG and the proposed method (MG) in simulating the One-piece at different mesh complexities. The numbers shown in the second and third rows are the time (in msec) taken for simulating one simulation time step. The simulation time step size was 11.11 msec. We used 100, 10, 0.01, 1e-5 for the stretch stiffness, shear stiffness, bending stiffness, density of cloth, respectively.

Our constraint method (DBCM) presented in Section 4.1 produces soft constraints, whose intensity can be varied with the coefficient k_{c}. We typically set k_{c}=100, a value comparable to the tensile stiffness. With this, the effect of the soft constraint is practically indistinguishable from hard constraints. Table 3 reports how much errors exist in the constrained particles that should stay fixed or slide on a plane. We measured displacements from the constrained configuration (point or plane) for all the constrained particles during the entire simulation. The table shows that, with k_{c}=100, the maximum error stays within the collision offset (0.2 in the normal direction), which is more than enough to maintain stable contact between cloth and body.

In addition, since DBCM is based on soft constraints, it is possible to produce the effect of friction very easily as described in Section 4.1. FIG. 8 (and accompanying video) shows frictional sliding-constraint test. In this example, we dropped six pieces of fabric with different k_{f} on the inclined plane at the same time. FIG. 8 (b) shows that the proposed method produces the effect of friction.

TABLE 3

| | k_{c} | | | | |
|---|---|---|---|---|---|
| Scenes | 10 | 100 | 1000 | 10000 | |
| Swinging Cloth | 1.421 | 0.131 | 0.0124 | 0.00125 | (cm) |
| (point-to-point constraints) | | | | | |
| One-piece | 1.216 | 0.139 | 0.0798 | 0.0102 | |
| (Sliding constraints) | | | | | |
| Jeans | 1.127 | 0.117 | 0.0951 | 0.0143 | |
| (Sliding constraints) | | | | | |

This table shows how closely the soft constraint of the DBCM emulates the hard constraint. We measured the (maximum displacement) error of the constrained particles at different values of k_{c}. The unit of the error is in centimeters.

### 6.3 Discussion

Convergence is one of the most important issues in developing an iterative linear system solver. The system matrix of Equation (3) is symmetric positive definite and block-diagonally dominant, since we added a positive block diagonal matrix D to the existing system matrix of Equation (2). The same is true for the coarsened system matrices in the lower levels. Thus, the linear systems of all levels always converge by either PCG or GS itself.

In the proposed multigrid method, however, applying a fixed number of post-smoothing (e.g. 10) in a V-Cycle always does not guarantee that residual error optimally decreases in that V-Cycle. If the current residual error in the V-Cycle is not below the some criteria (e.g. the residual error at the beginning of the V-Cycle), additional post smoothing iterations (e.g. 1020) are applied. In Sphere Test 2, the crumpled cloth (FIG. 5 (c)) at the end of the simulation was one of those cases. Although this reduces performance gain to a certain degree, our multigrid method still out-performed the MPCG.

In those cases, the correction procedure in the coarse grids may not be a great help for improving the finest level solution, since what is happening in the lower level does not properly approximate the situation happening in the finest level. It is an intrinsic problem of the hierarchical approaches including the multigrid method. We attribute it to MG's non-homogeneous interpretation of the wrinkles across different levels; MG models bending in the finest level mesh as tensile compression in the lower level meshes [21], [30]. Although M=3 or 4, and V(5,10) produced satisfactory results in almost cases, further study might reveal optimal choices.

### 7 CONCLUSION

In this paper, we presented the damper-based constraint method which can handle both point-to-point and frictional sliding constraints in the multigrid framework. Because this method uses soft constraints, it can coarsen the constraints defined in the finest level to the coarser levels. We also presented how the soft constraints can be coarsened across different levels, and showed through several experiments that the proposed constraint method along with the new coarsening scheme can solve the linear system up to several times faster in comparison with the MPCG without quality degradation even in collision-intensive cases. Although we employed soft constraints, we showed that their effect is practically identical to the hard constraints which have been widely used in clothing simulation. The proposed method is easy to implement and can be applied to existing clothing simulators which are based on implicit time integration.

### REFERENCES

[1] D. Baraff and A. Witkin, “Large steps in cloth simulation,” in Proceedings of the 25th annual conference on Computer graphics and interactive techniques, ser. SIGGRAPH '98. New York, N.Y., USA: ACM, 1998, pp. 43-54.
[2] R. Bridson, R. Fedkiw, and J. Anderson, “Robust treatment of collisions, contact and friction for cloth animation,” ACM Trans. Graph., vol. 21, pp. 594-603, July 2002.
[3] M. Muller, B. Heidelberger, M. Hennix, and J. Ratcliff, “Position” based dynamics,” J. Vis. Comun. Image Represent., vol. 18, pp. 109-118, April 2007.
[4] A. Brandt, “Multi-level adaptive solutions to boundary-value problems,” Mathematics of Computation, vol. 31, no. 138, pp. pp. 333-390, 1977.
[5] W. L. Briggs, V. E. Henson, and S. F. McCormick, A multigrid tutorial (2nd ed.). Philadelphia, Pa., USA: Society for Industrial and Applied Mathematics, 2000.
[6] A. Nealen, M. Muller, R. Keiser, E. Boxerman, and M. Carlson,” “Physically based deformable models in computer graphics,” Computer Graphics Forum, vol. 25, no. 4, pp. 809-836, 2006.
[7] M. Muller, J. Stam, D. James, and N. Th″urey, “Real time physics:” class notes,” in ACM SIGGRAPH 2008 classes, ser. SIGGRAPH '08. New York, N.Y., USA: ACM, 2008, pp. 88:1-88:90.
[8] M. Hauth, O. Etzmuss, and U. Tubingen, “A high performance solver for the animation of deformable objects using advanced numerical methods,” in In Proc. Eurographics 2001 (2001), Chalmers A., Rhyne T.-M., (Eds, 2001, pp. 319-328.
[9] P. Volino and N. Magnenat-Thalmann, “Implicit midpoint integration and adaptive damping for efficient cloth simulation: Collision detection and deformable objects,” Comput. Animat. Virtual Worlds, vol. 16, pp. 163-175, July 2005.
[10] K.-J. Choi and H.-S. Ko, “Stable but responsive cloth,” ACM Trans. Graph., vol. 21, no. 3, pp. 604-611, 2002.
[11] E. Grinspun, A. N. Hirani, M. Desbrun, and P. Schroder, “Discrete” shells,” in Proceedings of the 2003 ACM SIGGRAPH/Eurographics symposium on Computer animation, ser. SCA '03. Aire-la-Ville, Switzerland, Switzerland: Eurographics Association, 2003, pp. 62-67.
[12] M. Bergou, M. Wardetzky, D. Harmon, D. Zorin, and E. Grinspun, “A quadratic bending model for inextensible surfaces,” in Proceedings of the fourth Eurographics symposium on Geometry processing, ser. SGP '06. Aire-la-Ville, Switzerland, Switzerland: Eurographics Association, 2006, pp. 227-230.
[13] P. Volino, N. Magnenat-Thalmann, and F. Faure, “A simple approach to nonlinear tensile stiffness for accurate cloth simulation,” ACM Trans. Graph., vol. 28, pp. 105:1-105:16, September 2009.
[14] H. Wang, J. F. O'Brien, and R. Ramamoorthi, “Data-driven elastic models for cloth: modeling and measurement,” ACM Trans. Graph., vol. 30, pp. 71:1-71:12, August 2011.
[15] A. Witkin, K. Fleischer, and A. Barr, “Energy constraints on parameterized models,” SIGGRAPH Comput. Graph., vol. 21, pp. 225-232, August 1987.
[16] M. A. Otaduy, R. Tamstorf, D. Steinemann, and M. Gross, “Implicit contact handling for deformable objects,” Computer Graphics Forum, vol. 28, no. 2, pp. 559-568, 2009.
[17] R. Goldenthal, D. Harmon, R. Fattal, M. Bercovier, and E. Grinspun, “Efficient simulation of inextensible cloth,” ACM Trans. Graph., vol. 26, Jul. 2007.
[18] M. Bergou, S. Mathur, M. Wardetzky, and E. Grinspun, “Tracks: toward directable thin shells,” ACM Trans. Graph., vol. 26, no. 3, pp. 50:1-50:10, 2007.
[19] B. Thomaszewski, S. Pabst, and W. Straer, “Continuum-based strain limiting.” Computer Graphics Forum, vol. 28, no. 2, pp. 569-576, 2009.
[20] M. Muller, “Hierarchical Position Based Dynamics,” in VRIPHYS, 2008, pp. 1-10.
[21] H. Wang, J. O'Brien, and R. Ramamoorthi, “Multi-resolution isotropic strain limiting,” ACM Trans. Graph., vol. 29, pp. 156:1-156:10, December 2010.
[22] Y. Lee, S.-E. Yoon, S. Oh, D. Kim, and S. Choi, “Multi-resolution cloth simulation,” Computer Graphics Forum (Pacific Graphics), vol. 29, no. 7, 2010.
-[23] N. Chentanez and M. Muller, “A multigrid fluid pressure solver” handling separating solid boundary conditions,” in Proceedings of the 2011 ACM SIGGRAPH/Eurographics Symposium on Computer Animation, ser. SCA '11. New York, N.Y., USA: ACM, 2011, pp. 83-90.
[24] Y. Zhu, E. Sifakis, J. Teran, and A. Brandt, “An efficient multigrid method for the simulation of high-resolution elastic solids,” ACM Trans. Graph., vol. 29, pp. 16:1-16:18, April 2010.
[25] A. McAdams, Y. Zhu, A. Selle, M. Empey, R. Tamstorf, J. Teran, and E. Sifakis, “Efficient elasticity for character skinning with contact and collisions,” ACM Trans. Graph., vol. 30, pp. 37:1-37:12, August 2011.
[26] M. Kazhdan and H. Hoppe, “Streaming multigrid for gradientdomain operations on large images,” ACM Trans. Graph., vol. 27, pp. 21:1-21:10, August 2008.
[27] L. Shi, Y. Yu, N. Bell, and W.-W. Feng, “A fast multigrid algorithm for mesh deformation,” ACM Trans. Graph., vol. 25, pp. 1108-1117, July 2006.
[28] J. Georgii and R. Westermann, “A multigrid framework for real-time simulation of deformable bodies,” Comput. Graph., vol. 30, pp. 408-415, June 2006.
[29] S. Oh, J. Noh, and K. Wohn, “A physically faithful multigrid method for fast cloth simulation,” Comput. Animat. Virtual Worlds, vol. 19, pp. 479-492, September 2008.
[30] M. Muller and N. Chentanez, “Wrinkle meshes,” in” Proceedings of the 2010 ACM SIGGRAPH/Eurographics Symposium on Computer Animation, ser. SCA '10. Aire-la-Ville, Switzerland, Switzerland: Eurographics Association, 2010, pp. 85-92.
[31] H. Wang, F. Hecht, R. Ramamoorthi, and J. O'Brien, “Example based wrinkle synthesis for clothing animation,” ACM Trans. Graph., vol. 29, pp. 107:1-107:8, July 2010.
[32] E. de Aguiar, L. Sigal, A. Treuille, and J. K. Hodgins, “Stable spaces for real-time clothing,” ACM Trans. Graph., vol. 29, pp. 106:1-106:9, July 2010.
[33] W.-W. Feng, Y. Yu, and B.-U. Kim, “A deformation transformer for real-time cloth animation,” ACM Trans. Graph., vol. 29, pp. 108:1-108:9, July 2010.
[34] D. Rohmer, T. Popa, M.-P. Cani, S. Hahmann, and A. Sheffer, “Animation wrinkling: augmenting coarse cloth simulations with realistic-looking wrinkles,” ACM Trans. Graph., vol. 29, pp. 157:1-157:8, December 2010.
[35] L. Kavan, D. Gerszewski, A. W. Bargteil, and P.-P. Sloan, “Physicsinspired upsampling for cloth simulation in games,” ACM Trans. Graph., vol. 30, pp. 93:1-93:10, August 2011.
[36] P. Alliez, D. Cohen-Steiner, M. Yvinec, and M. Desbrun, “Variational tetrahedral meshing,” ACM Trans. Graph., vol. 24, pp. 617-625, July 2005.
[37] M. F. Adams, “A distributed memory unstructured gauss-seidel algorithm for multigrid smoothers,” in Proceedings of the 2001 ACM/IEEE conference on Supercomputing, ser. Supercomputing '01. New York, N.Y., USA: ACM, 2001, pp. 4-4.
[38] D. Baraff, A. Witkin, and M. Kass, “Untangling cloth,” ACM Trans. Graph., vol. 22, pp. 862-870, July 2003.

What is claimed is:

1. A method of cloth simulation using a constrainable multigrid, the method comprising steps of:
a) mapping information of geometry of N material points, of the cloth into a mesh of nodes, having a 3N position vector x, a 3N×3N mass matrix M, and a 3N velocity vector v;
b) calculating a change of geometry of the mesh of nodes at a plurality of time steps using a multigrid method by solving a time-varying partial differential equation at multiple resolutions or levels; and
c) providing a hierarchical mesh through restriction or coarsening by down-sampling from level m to m−1 or prolongation or interpolation by up-sampling from level m to m+1;
d) transferring soft constraints between different hierarchical levels using a damper-based constraint method;
e) updating the position vector x and the velocity vector v of the mesh nodes; and
f) displaying an updated state of the mesh of nodes using updated position vector x and velocity vector v on a display,
wherein the coarsening of mesh is performed by coarsening a system matrix of the time-varying partial differential equation through the damper-based constraint method,
wherein the system matrix is changed by damper matrices and displacement forces.

2. The method of claim 1, wherein the time-varying partial differential equation is given
Eq. 1,
which is discretized by an implicit integration method to
Eq. 2,
where h is a time-step, f is a 3N force vector, and n is a superscript of the time-step.

3. The method of claim 1, wherein the mesh is trianuglar, wherein the step for providing a hierarchical mesh comprises a constrained Delaunay triangulation to generate finer or coarser meshes, and wherein for prolongation each triangle having three parent particles at level m is subdivided into four smaller triangles by inserting mid-particles at mid-points of three edges, and for restriction the mid-particles are removed.

4. The method of claim 3, wherein a 3×3 damper matrix Dᵢ, a directional damper, constrains particle is movement along a particular direction by being added to a block diagonal term of the system matrix in
Eq. 3,
where
Eq. 4.

5. The method of claim 4, wherein the Dᵢ is given
Eq. 4,
where nᵢ is a prohibited direction of the particle i.

6. The method of claim 5, wherein the directional damper is a sum of a 3×3 orthogonal projector and a 3×3 complementary projector.

7. The method, of claim 4, wherein the displacement force is given by
Eq. 5,
where dᵢ a displacement determined by a movement of a solid object in contact with the particle i if there is a positional change along the constrained direction.

8. The method of claim 1, wherein the step for transferring soft constraints to a coarser levels from level m+1 to level m comprises a step for determining which particles are constrained in level m, for each constrained particle which type of constraint is to be used, and what value is used for constraint coefficients.

9. The method of claim 8, wherein coarsening is applied recursively until a desired coarser level is reached.

10. The method of claim 1, further comprising a step for performing a plurality of relaxations to reduce residual errors at each level, wherein the step comprises a preconditioned conjugate gradient scheme and a Gauss-Seidal scheme.

11. The method of claim 10, where the step for providing a hierarchical mesh is performed by an algorithm
Algorithm 1.
